(19) United States
(12) Patent Application Publication
(10) Pub. No.: US 2002/0194882 A1
(43) Pub. Date: Dec. 26, 2002

(54) Method of reducing the boron required in a glass batch

(75) Inventor: John Albert Hockman, Bath, PA (US)

Correspondence Address: Marvin J. Powell, 1 Highland Avenue, Bethlehem, PA, 18017, US

(73) Assignee: Specialty Minerals (Michigan) Inc.

(21) Appl. No.: 09/878,642

(22) Filed: Jun. 11, 2001

(51) Int. Cl. C03B 5/16; C03B 5/225; C03B 37/00

(52) U.S. Cl. 65/482; 65/134.3

(57) ABSTRACT

A method is provided for producing glass. A calcium magnesium silicate is used to replace some or all of magnesium oxide being used as an aid to reduce the use of boron during glass batch operations. Reduced batch-free times and operating temperatures are additional benefits.

### FIELD OF THE INVENTION

The present invention relates to glass production methods. In particular, it relates to glass production methods in which a magnesium oxide component is used in forming a glass batch to reduced the requirement of the boron oxide needed for a specific glass composition.

### BACKGROUND

In many borosilicate glasses production methods, such as that for making fiberglass, lighting glass and others, a magnesium oxide component is added to the glass batch to reduce the requirement of boron oxide. A typical experience is that a reduction of up to about half of the boron oxide component of the glass batch can be achieved by the addition of magnesium oxide. While this solves one aspect of the glass production, it can on occasion result in production problems. One problem is that the formed glass batch melts slower, has increased batch-free times or requires greater production temperatures than batch formed with boron oxide alone. These problems result in technical and economics barriers to the substitution of magnesium oxide for boron oxides in glass batches. There remains a need for improved compositions and production methods which permit the reduction of the required amounts of boron oxides.

### SUMMARY

An object of the present invention is the reduction of the requirement of boron oxide in glass compositions. Another object is the replacement of boron oxide in glass batches by magnesium oxides and other components. Yet another object is the reduction of operating time for batch-free compositions and/or the reduction of refining temperatures in producing boron oxide or equivalent compositions. These and others objects are achieved by a method of producing a glass batch comprising admixing boron oxide, magnesium oxide, a calcium magnesium silicate, and other glass components to produce a glass batch and then melting, refining and forming a glass product. In one embodiment, the magnesium oxide component is eliminated.

### DESCRIPTION OF PREFERRED EMBODIMENTS

One embodiment of the present invention is a method of producing a glass product from a glass batch formed from an embodied mixture. Such mixture is formed by mixing together an amount of a boron oxide compound, an amount of a calcium magnesium silicate compound, an optional amount of a magnesium oxide compound, and an amount of other glass components to produce a formed glass batch. The formed glass batch is then melted and refined to produce a glass composition which is finally formed into a glass product.

The respective amounts of the boron oxide compound, calcium magnesium silicate compound, optional magnesium oxide compound, and other glass components is dependent upon the glass formula being produced. As used herein, the term “comparative glass batch” or “comparative glass product” means a glass batch or product which is equivalent in oxide values, except that the value of boron oxide equivalent is less for an embodied glass product made with the present invention than that made with known processes which do not use a calcium magnesium silicate compound as described herein. It has been unexpectedly discovered that by using the calcium magnesium compound described herein that less boron values are needed to attain the same result as the amount used in known methods. It was further unexpectedly found that in the method using magnesium oxide to reduce the amount of boron needed for a particular purpose, that the use of an embodied magnesium silicate compound further reduced the amount of magnesium oxide needed to achieve the result. In a preferred method the amount of said magnesium oxide compound is reduced to about zero. What is further unexpectedly discovered is that the boron in the final glass product produced by the present inventive method has value more than that of a residual impurity which has value only in the method of making and not in the final product characteristics.

In one preferred embodiment the method produces a formed glass product composed of at least ten percent by weight less boron oxide than and has an equivalent surface property to a comparative glass product formed from a second glass batch produced by a method comprising admixing a second amount of a boron oxide compound, an optional second amount of a magnesium oxide compound, and a second amount of other glass components in the absence of an amount of said calcium magnesium silicate compound.

The calcium magnesium silicate of the present invention can be a natural resource or one attained by synthetic produced. A preferred calcium magnesium compound is that described in U.S. Pat. No. 6,211,103 B1. A more preferred calcium magnesium silicate has an empirical formula of CaₓMg_{y}SiOₓ, and the values of x and y are independently from about 0.1 to about 0.6 and z is a value to balance the oxidation state of the compound.

An advantage of the present invention is that the refining batch-free time of said formed glass batch is at least twenty-five percent less than that of a second glass batch of a comparative composition. A further advantage is that the temperature for refining of the formed glass batch using the present invention is at least 50 degrees Centigrade less than that required for a comparative composition using known methods to produced an equivalent batch-free time. In a preferred method the batch-free time is equivalent to or less than the batch-free time of an equivalent composition produced with less magnesium oxide. An alternative advantage is that the temperature for refining is equivalent to or less than the temperature for refining of an equivalent composition produced with less magnesium oxide. A preferred application is use of the present inventive method to produce a glass product which is continuous strand fiberglass.

The following example illustrates, but does not limit, the present invention.

### EXAMPLE

A glass batch for E-type fiberglass is formed in which dolomite or dolomitic lime, as a source of MgO, is added to reduced the amount borax, as a source of B₂O₃, to attain a set of measured values for chemical durability. A second batch is formed identical in composition except that an amount of calcium magnesium silicate is substituted for an amount of the dolomite or dolomitic lime. The calcium magnesium silicate is Synsil® silicate, from Synsil Products Inc., and has the following composition:

| Oxide Component | Mass Percent |
|---|---|
| CaO | 24.5 |
| MgO | 17.8 |
| SiO₂ | 53.5 |
| Al₂O₃ | 3.4 |
| Fe₂O₃ | 0.12 |
| Na₂O | 0.40 |

The second batch using Synsil® silicate has reduced batch free time and over-all better melting properties with the same chemical durability property retained.

What is claimed is:

1. A method of producing a glass product comprising forming a glass batch by admixing an amount of a boron oxide compound, an amount of a calcium magnesium silicate compound, an optional amount of a magnesium oxide compound, and an amount of other glass components to produce said formed glass batch; then melting and refining said formed glass batch to produce a glass composition; and finally forming from said glass composition a glass product.

2. The method of claim 1 wherein the amount of said magnesium oxide compound is about zero.

3. The method of claim 1 wherein the calcium magnesium silicate has an empirical formula of CaₓMg_{y}SiOₓ, and the values of x and y are independently from about 0.1 to about 0.6 and z is a value to balance the oxidation state of the compound.

4. The method of claim 1 wherein said formed glass product is composed of at least ten percent by weight less boron oxide than and has an equivalent surface property to a comparative glass product formed from a second glass batch produced by a method comprising admixing a second amount of a boron oxide compound, an optional second amount of a magnesium oxide compound, and a second amount of other glass components in the absence of an amount of said calcium magnesium silicate compound.

5. The method of claim 1 wherein the refining batch-free time of said formed glass batch is at least twenty-five percent less than that of said second glass batch of said comparative composition.

6. The method of claim 1 wherein the temperature for refining of said formed glass batch is at least 50 degrees Centigrade less than that required for said comparative composition to produced an equivalent batch-free time.

7. The method of claim 4 wherein the batch-free time is equivalent to or less than the batch-free time of an equivalent composition produced with less magnesium oxide.

8. The method of claim 4 wherein the temperature for refining is equivalent to or less than the temperature for refining of an equivalent composition produced with less magnesium oxide.

9. The method of claim 1 wherein the glass product is continuous strand fiberglass.
